(19) United States
(12) Patent Application Publication
(10) Pub. No.: US 2019/0321247 A1
(43) Pub. Date: Oct. 24, 2019

(54) FECES COLLECTING BAG WITH AN EXHAUST FUNCTION

(71) Applicant: Lien-Kung WANG, New Taipei City (TW)

(72) Inventors: Han Ping WANG, New Taipei City (TW); Tai-Li WANG, New Taipei City (TW); Shun-Hsien WANG, New Taipei City (TW)

(21) Appl. No.: 15/960,170

(22) Filed: Apr. 23, 2018

(51) Int. Cl. A61G 9/00

(52) U.S. Cl. CPC A61G 9/00

(57) ABSTRACT

A feces collecting bag with an exhaust function is provided. The feces collecting bag includes a collection bag body, an exhaust assembly and a drainage connector. The collection bag body has an accommodating space inside. The exhaust assembly is disposed at an upper end of the collecting bag body for discharging the gas within the accommodating space. The drainage connector is arranged on an upper surface of the collection bag body and is connected and fixed with a switch feces connector.

### BACKGROUND OF THE INVENTION

### Field of the Invention

The present invention relates to a feces collecting bag, and more particularly, relates to a feces collecting bag with an exhaust function.

### Descriptions of the Related Art

For feces collecting bags currently used for medical purposes, a connecting tube thereof for communicating with the outside is only provided with a single drainage connector to receive feces from a feces drainage tube.

However, the defecation of a patient is often accompanied by exhaust gas generated by the gastrointestinal movement. Therefore, in practical use, the feces collecting bag currently available not only stores the feces of the patient, but the pressure inside the feces collecting bag is increased and the volume thereof is expanded due to the exhaust gas filling the inner space of the feces collecting bag. In this way, medical workers need to check frequently, and it is hard to effectively carry out the feces collecting operation.

Moreover, when the feces and the exhaust gas stored in the feces collecting bag have reached the threshold, the exhaust gas stored within the feces collecting bag is likely to flow back into the intestinal tract of the patient and cause other discomforts once the feces collecting bag is not changed in time.

Thus, the medical workers take the following steps in order to discharge the exhaust gas accumulated within the inner space of the feces collecting bag to effectively use the feces collecting bag: loosening the drainage connector from the feces drainage tube so that the drainage connector is in communication with the outside environment, and discharging the exhaust gas accumulated within the inner space of the feces collecting bag to the outside environment via the drainage connector through a squeezing operation.

However, part of the feces being drained will remain in the drainage connector, so the feces remaining in the drainage connector will inevitably leak to the outside accompanied by disgusting exhaust smell in the aforesaid exhaust manner.

Accordingly, an urgent need exists in the art to provide a feces collecting bag with an exhaust function so as to effectively collect the feces and avoid the leakage of the feces described above, and meanwhile achieve the filtering and deodorization of the exhaust gas.

### SUMMARY OF THE INVENTION

An objective of the present invention is to provide a feces collecting bag with an exhaust function, and an exhaust assembly of the feces collecting bag can discharge the gas within a collecting bag body in an active or passive way, so the purpose of effectively using the collecting bag body to collect feces can be achieved while reducing the gas pressure inside the collecting bag body.

Another objective of the present invention is to provide a feces collecting bag with an exhaust function, and an exhaust assembly of the feces collecting bag comprises a deodorant filter, so the gas discharged from the collecting bag body can be effectively filtered and deodorized to avoid the generation of bad odors.

Yet another objective of the present invention is to provide a feces collecting bag with an exhaust function, and a drainage connector of the feces collecting bag comprises a release-preventing plug which may be configured to snap fit a switch feces connector to ensure the connection between the drainage connector and the switch feces connector and prevent the release of the drainage connector from the switch feces connector. Meanwhile, after the collection of the feces is finished, the release-preventing plug may also be used to seal the drainage connector to prevent the leakage of the feces from the collecting bag body.

To achieve the aforesaid objectives, a feces collecting bag with an exhaust function disclosed in the present invention comprises a collecting bag body, an exhaust assembly and a drainage connector. The collecting bag body has an accommodating space therein. The exhaust assembly is disposed at an upper end of the collecting bag body for discharging the gas within the accommodating space. The drainage connector is arranged on an upper surface of the collection bag body and is adapted to be connected and fixed with a switch feces connector.

To achieve the aforesaid objectives, the exhaust assembly of the feces collecting bag according to the present invention comprises a connecting tube and a deformed exhaust head, the deformed exhaust head is nested at an end of the connecting tube, and the other end of the connecting tube connects with the upper end of the collecting bag body.

To achieve the aforesaid objectives, the deformed exhaust head of the feces collecting bag according to the present invention has a deformable notch, and the deformable notch is petal-shaped, cross-shaped, X-shaped or straight line-shaped.

To achieve the aforesaid objectives, the deformed exhaust head of the feces collecting bag according to the present invention is made of a silicone material.

To achieve the aforesaid objectives, the shore hardness of the deformed exhaust head of the feces collecting bag according to the present invention ranges from A5 to A90.

To achieve the aforesaid objectives, the thickness of the deformed exhaust head of the feces collecting bag according to the present invention ranges from 0.05 mm to 5 mm.

To achieve the aforesaid objectives, the exhaust assembly of the feces collecting bag according to the present invention comprises a deodorant filter, and the deodorant filter is disposed inside the deformed exhaust head and located at a side opposite to the connecting tube.

To achieve the aforesaid objectives, the exhaust assembly of the feces collecting bag according to the present invention further comprises a fixing sheet that is configured to fix the deodorant filter inside the deformed exhaust head.

To achieve the aforesaid objectives, a release-preventing plug is disposed at an outer side of the drainage connector of the feces collecting bag according to the present invention, and the release-preventing plug is configured to seal the drainage connector or snap fit the switch feces connector.

To achieve the aforesaid objectives, volume scale marks are printed on the surface of the collecting bag body of the feces collecting bag according to the present invention.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is an exploded view of a feces collecting bag according to the present invention;

FIG. 2 is a front view of the feces collecting bag according to the present invention;

FIG. 3 is a side view of the feces collecting bag according to the present invention;

FIG. 4 is a top view of an exhaust assembly of the feces collecting bag according to the present invention;

FIG. 5 is a cross-sectional view taken along line A-A of FIG. 4;

FIG. 6 is an exploded view of the exhaust assembly of the feces collecting bag according to the present invention;

FIG. 7 is a schematic view illustrating the assembly of the feces collecting bag and a switch feces connectors according to the present invention; and

FIG. 8 is a schematic view illustrating a release-preventing plug of a drainage connector of the feces collecting bag snap fitting the switch feces connector according to the present invention.

### DESCRIPTION OF THE PREFERRED EMBODIMENT

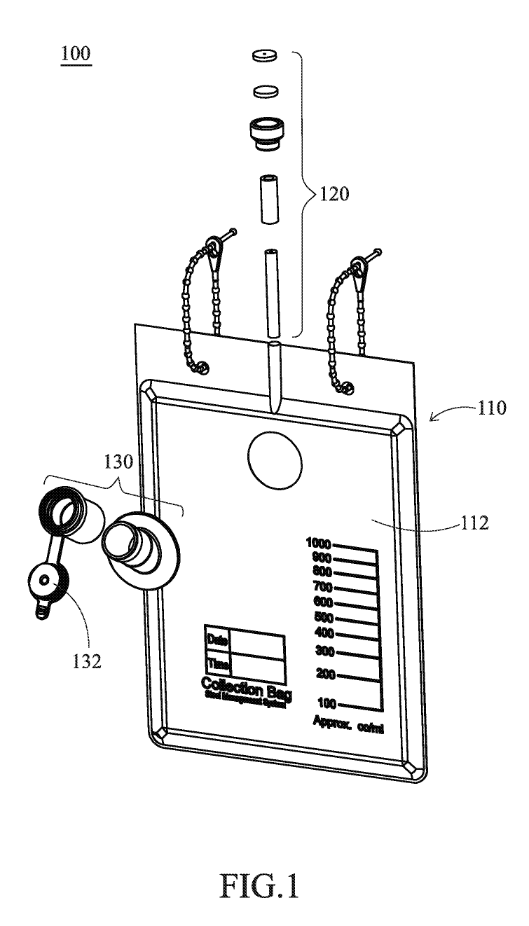

As shown in FIG. 1, a feces collecting bag 100 with an exhaust function according to the present invention is mainly constituted by a collecting bag body 110, an exhaust assembly 120 and a drainage connector 130.

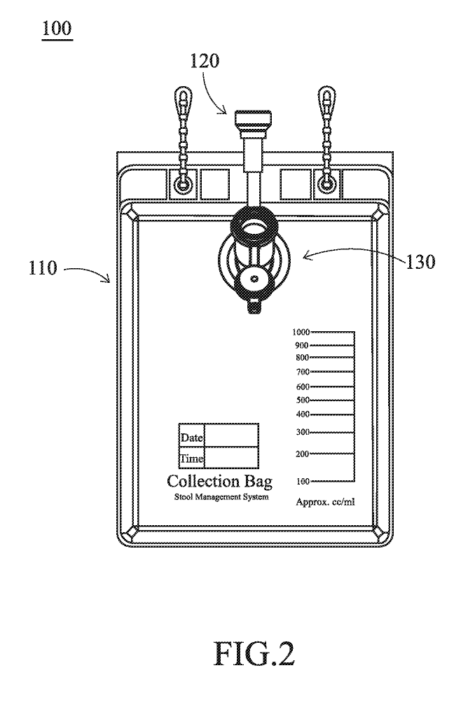

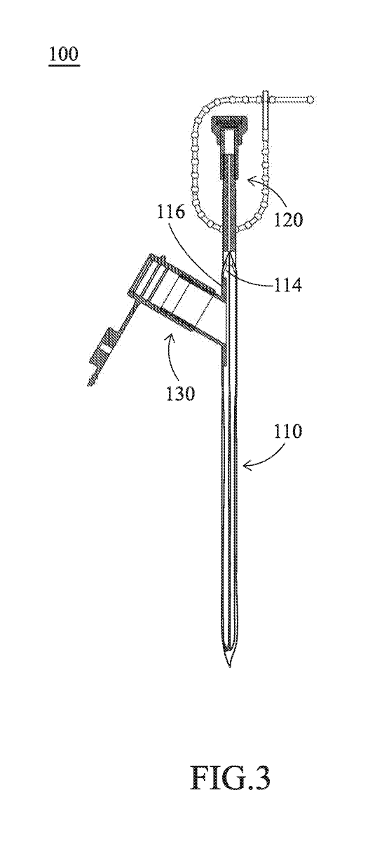

In detail, referring to FIG. 2 and FIG. 3 together, the collecting bag body 110 has an accommodating space 112 therein. The exhaust assembly 120 is disposed at an upper end 114 of the collecting bag body 110 for discharging the gas (which means the exhaust gas generated by the gastrointestinal movement herein) within the accommodating space 112. The drainage connector 130 is arranged on an upper surface 116 of the collection bag body 110, and the drainage connector 130 is adapted to be connected and fixed with a switch feces connector 200.

It shall be appreciated that, in an embodiment depicted in the present invention, an upper end 114 of the collecting bag body 110 is preferably located at the center of the top of the collecting bag body 110, and the upper surface 116 of the collecting bag body 110 is the surface adjacent to the upper end 114. By the aforesaid arrangement, after the drainage connector 130 inclining at a particular angle is disposed on the upper surface 116 of the collecting bag body 110, the feces entering from the switch feces connector 200 can be effectively directed into the bottom of the collecting bag body 110 to be collected under the action of gravity no matter the feces is in the solid or liquid state, without contacting the upper end 114 of the collecting bag body 110 in the collecting process.

On the other hand, as depicted in FIG. 3, the position of the upper end 114 of the collecting bag body 110 is disposed higher than the upper surface 116, so the gas discharged into the collecting bag body 110 along with the feces will not flow back into the switch feces connector 200 when the gas is accumulated at the center of the top (i.e., the upper end 114) of the collecting bag body 100.

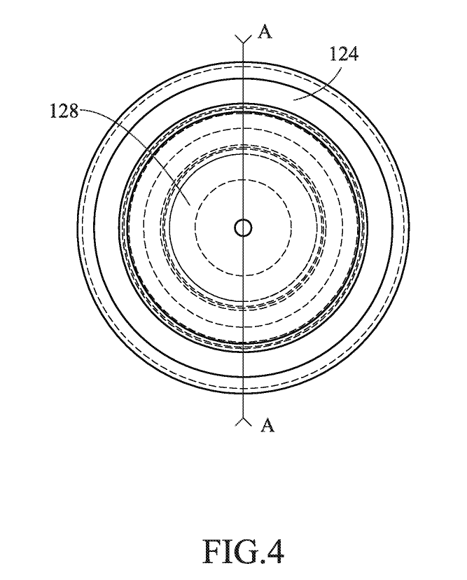

Referring to FIG. 4 to FIG. 6, the exhaust assembly 120 of the feces collecting bag 100 according to the present invention comprises a connecting tube 122 and a deformed exhaust head 124. The connecting tube 122 may be constituted by combining tubes having different apertures; the deformed exhaust head 124 is nested at an end (an upper end) of the connecting tube 122, and the other end (a lower end) of the connecting tube 122 connects with the upper end 114 of the collecting bag body 110.

The deformed exhaust head 124 has a deformable notch 124a, and the deformable notch 124 is petal-shaped in the embodiment shown in the figures, but it is not limited thereto. In other words, the deformable notch 124a may also be presented as cross-shaped, X-shaped or straight line-shaped by those of ordinary skill in the art depending on different design requirements or considerations. Moreover, in the embodiment shown in the figures, the deformed exhaust head 124 is made of a silicone material to achieve the purpose of being deformable, the shore hardness of the deformed exhaust head 124 preferably ranges from A5 to A90, and the thickness of the deformed exhaust head 124 preferably ranges from 0.05 mm to 5 mm, but it is also not limited thereto.

Through the aforesaid definition of the shape, hardness and thickness of the deformed exhaust head 124, the exhaust pressure of the deformed exhaust head 124 can be selectively controlled. For example, in the case where no external force is exerted onto the collecting bag body 110, the gas in the collecting bag body 110, when accumulating up to the aforesaid exhaust pressure, can actively force the deformable notch 124a in the deformed exhaust head 124 to deform and generate a gap for discharging the gas to the outside environment. Even if the amount of the gas in the collecting bag body 110 is insufficient, the pressure inside the collecting bag body 110 can also be increased when the medical workers squeeze the collecting bag body 110 so that the deformable notch 124a in the deformed exhaust head 124 is forced to be deformed and a gap is generated accordingly for discharging the gas to the outside environment.

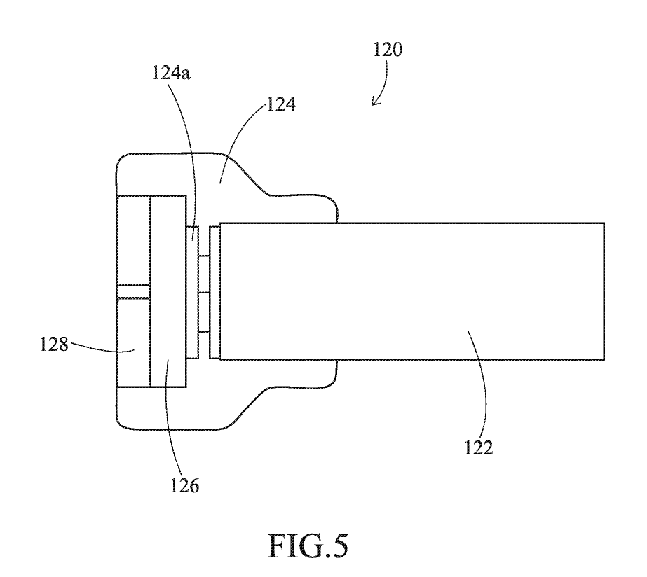

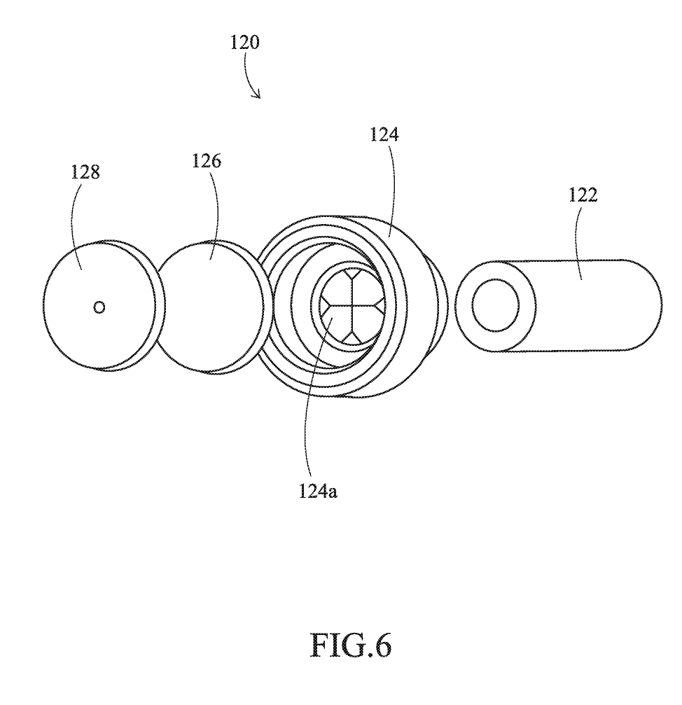

Still referring to FIG. 5 and FIG. 6, the exhaust assembly 120 may further comprise a deodorant filter 126 and a fixing sheet 128. As shown in FIG. 5, the deodorant filter 126 is disposed within the deformed exhaust head 124 and located at a side opposite to the connecting tube 122. The fixing sheet 128 is configured to fix the deodorant filter 126 inside the deformed exhaust head 124 to prevent the release of the deodorant filter 126. In more detail, the deodorant filter 126 and the connecting tube 122 are respectively disposed at the left and the right sides of the deformable notch 124a in the deformed exhaust head 124 so that the deformable notch 124a is interposed therebetween, thereby ensuring that the gas being discharged will certainly flow through the deodorant filter 126 first so as to complete the step of filtering and deodorization.

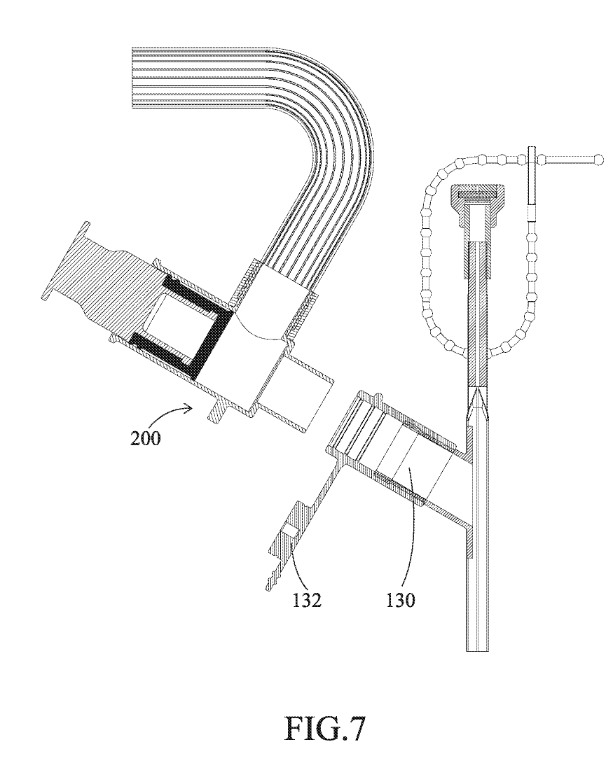

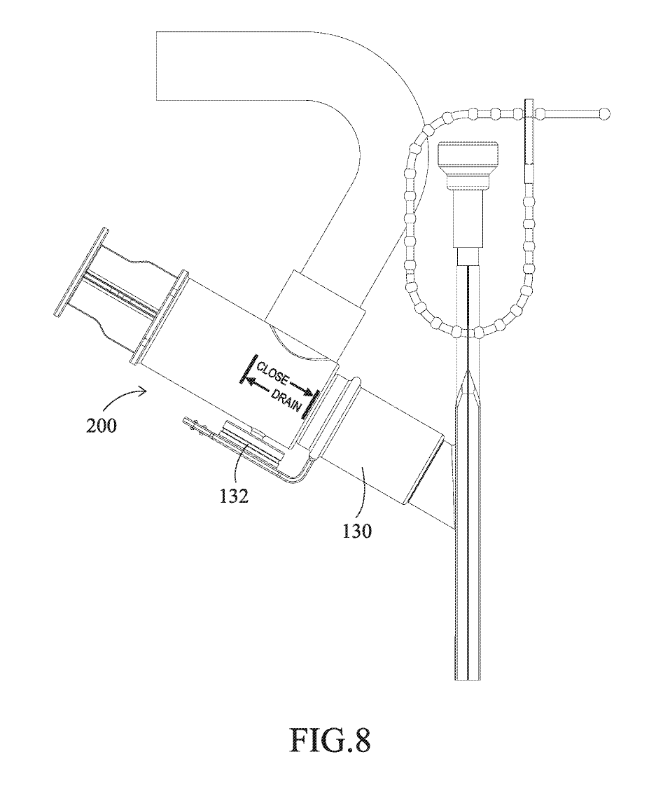

Referring to FIG. 7 and FIG. 8, in an embodiment shown in the present invention, a release-preventing plug 132 is disposed at an outer side of the drainage connector 130 of the feces collecting bag 100. When the drainage connector 130 is fixed and connected with the switch feces connector 200, the release-preventing plug 132 is adapted to snap fit the switch feces connector 200, thereby ensuring the connection between the drainage connector 130 and the switch feces connector 200 and meanwhile preventing the release of the drainage connector 130 from the switch feces connector 200. On the other hand, after the feces collection is finished, the release-preventing plug 132 may also be nested back onto the drainage connector 130 to seal the drainage connector 130 and prevent the leakage of the feces from the collecting bag body 110.

Additionally, in the embodiment depicted in the figures, volume scale marks may be further printed on the surface of the collecting bag body 110 of the feces collecting bag 100, thereby making it convenient for the medical workers to measure and record the defecation status of the patient.

According to the above descriptions, the exhaust assembly of the feces collecting bag of the present invention can discharge the gas within the collecting bag body while maintaining the connection between the drainage connector and the switch feces connector, so the gas pressure inside the collecting bag body can be effectively reduced to achieve the purpose of sufficiently using the inner space of the collecting bag body to collect the feces, as compared to the prior art. Furthermore, the deodorant filter of the exhaust assembly can also effectively filter and deodorize the gas discharged from the collecting bag body, thereby preventing the generation of bad odors. Additionally, on the one hand, the release-preventing plug of the drainage connector may be used to snap fit the switch feces connector, thereby ensuring the connection between the drainage connector and the switch feces connector and preventing the release of the drainage connector from the switch feces connector. On the other hand, after the feces collection is finished, the release-preventing plug may also be used to seal the drainage connector and prevent the leakage of the feces from the collecting bag body.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A feces collecting bag with an exhaust function, comprising:
a collecting bag body, having an accommodating space therein;
an exhaust assembly, being disposed at an upper end of the collecting bag body for discharging the gas within the accommodating space; and
a drainage connector, being arranged on an upper surface of the collection bag body and being adapted to be connected and fixed with a switch feces connector.

2. The feces collecting bag of claim 1, wherein the exhaust assembly comprises a connecting tube and a deformed exhaust head, the deformed exhaust head is nested at an end of the connecting tube, and the other end of the connecting tube connects with the upper end of the collecting bag body.

3. The feces collecting bag of claim 2, wherein the deformed exhaust head has a deformable notch, and the deformable notch is petal-shaped, cross-shaped, X-shaped or straight line-shaped.

4. The feces collecting bag of claim 2, wherein the deformed exhaust head is made of a silicone material.

5. The feces collecting bag of claim 2, wherein the shore hardness of the deformed exhaust head ranges from A5 to A90.

6. The feces collecting bag of claim 2, wherein the thickness of the deformed exhaust head ranges from 0.05 mm to 5 mm.

7. The feces collecting bag of claim 2, wherein the exhaust assembly comprises a deodorant filter, and the deodorant filter is disposed inside the deformed exhaust head and located at a side opposite to the connecting tube.

8. The feces collecting bag of claim 7, wherein the exhaust assembly further comprises a fixing sheet that is configured to fix the deodorant filter inside the deformed exhaust head.

9. The feces collecting bag of claim 1, wherein a release-preventing plug is disposed at an outer side of the drainage connector, and the release-preventing plug is configured to seal the drainage connector or snap fit the switch feces connector.

10. The feces collecting bag of claim 1, wherein volume scale marks are printed on the surface of the collecting bag body.
